(19) United States
(12) Patent Application Publication
(10) Pub. No.: US 2009/0237641 A1
(43) Pub. Date: Sep. 24, 2009

(54) SPIN MEASUREMENT METHOD AND APPARATUS

(76) Inventor: Brian Francis Mooney, County Dublin (IE)

Correspondence Address: SNELL & WILMER LLP (OC), 600 ANTON BOULEVARD, SUITE 1400, COSTA MESA, CA, 92626, US

(21) Appl. No.: 11/721,038

(22) PCT Filed: Dec. 6, 2005
(86) PCT No.: PCT/IE2005/000139

§ 371 Date: Jun. 6, 2007

(30) Foreign Application Priority Data
Dec. 6, 2004 (IE) S2004/819

(51) Int. Cl. G01P 3/36; G01K 11/00; G01J 1/58

(52) U.S. Cl. 356/28; 374/161; 250/483.1; 374/E13.001

(57) ABSTRACT

A method and apparatus for measuring or determining spin characteristics of a moving object such as a golf ball (1) is disclosed. The object includes one or more detectable marks (2) or object features. Event characteristics associated with the entry, passage or exit of the marks (2) or object features are detected or recorded at a reference or boundary. Marks are physically effected by heating a region on the surface of the object to a detectably different temperature.

The present invention relates to a method and apparatus for measurement of the spin characteristics of a moving object. The invention relates more specifically, but not exclusively, to a method and apparatus for measuring the spin characteristics of a golf ball which has been struck by a golf club. The typical spin characteristics of a moving golf ball are the magnitude of its back spin and magnitude and direction of its side spin.

When a golf ball is struck by a golf club, a rotational motion is usually transmitted to the ball. In the case of a golf ball being perfectly struck by a club such as a driver, the lofted club face imparts a significant back spin to the ball, causing it to rotate about a horizontal axis. If the ball is unevenly struck, as frequently occurs, an additional component of side spin is imparted and the ball rotates about a resultant axis which is inclined to the horizontal and which is frequently understood by technical golf players in relation to its back spin and side spin components. The ball will not usually display any significant rifle spin, i.e. rotation about an axis in the direction of travel. In practice, over the common ranges of golf ball shots struck with driver or low wood clubs, the resultant axis of rotation is usually within an angle of about ±10° to the horizontal, the direction of slope depending on the rotational direction of the component of side spin. Side spin is important in the game of golf because it can cause significant lateral movement during the flight of the ball. If the resultant axis is tilted down to the right, the ball will drift to the right during flight displaying what is commonly called ‘slicing’ for right handed players. Tilting down to the left will result in the ball drifting to the left during flight, displaying what is commonly called ‘hooking’ for right handed players. The directions are reversed for left handed players.

Although side spin is of great importance in a golf shot, it has traditionally been found difficult to measure for various reasons. Firstly, it is just one component of a high energy compound movement. Secondly, it is only a very small part of this compound movement. The total spin energy of a ball is usually much less than 1% of its linear kinetic energy and the side spin energy is just a small part of the total spin energy.

For example, with a typical drive shot with a launch speed of 65 m/s and backspin rate of 50 RPS, the side spin may vary from zero up to about 10 RPS for a badly sliced or hooked shot. In this instance, the ball will travel 1.3 m before it executes one complete revolution of backspin. During this period, which occurs over just 20 ms, the ball will execute a sidespin component movement varying from zero to about 72°, depending on how badly the shot is sliced or hooked.

The prior art has produced various devices which claim to measure the spin characteristics of a golf ball which has been struck by a golf club.

Sullivan et al., U.S. Pat. No. 4,136,387; Gobush et al., U.S. Pat. No. 5,471,383; Lutz et al., 6,592,465 and Rankin, US 20040030527, all disclose devices which are stated to measure spin characteristics of a golf ball. These devices employ one or more high-speed cameras to capture a plurality of two-dimensional images of a pre-marked moving ball. Changes in the two-dimensional positions of the marks are analysed by computers to determine spin characteristics.

Although these devices have been found suitable for measuring spin characteristics in a laboratory type environment, they are not generally suitable for use by ordinary golfers due to the high cost and bulk of the apparatus and the difficulties in setting-up, calibrating and maintaining them. The present invention attempts to overcome these deficiencies of the prior art.

The invention is defined in the attended method and apparatus claims which are incorporated into the description by reference thereto.

The invention will now be described more particularly with reference to the accompanying drawings, which show, by way of example only, embodiments of a method and apparatus according to the invention.

The following is an index of the reference numerals used in the drawings:
1. Golf ball.
2. Mark on golf ball.
3. Direction of linear movement of golf ball.
4. Support.
5. Playing surface.
6. Marking means.
7. Rays from marking means.
8. Detection means housing.
9. Anamorphic lens.
10. Heat rays from mark.
11. Heat sensor.
12. Object feature radiation emitter means.
13. Rays from object feature radiation emitter means.
14. Reflected rays from ball.
15. Upper heat sensor.
16. Lower heat sensor.

In the drawings:

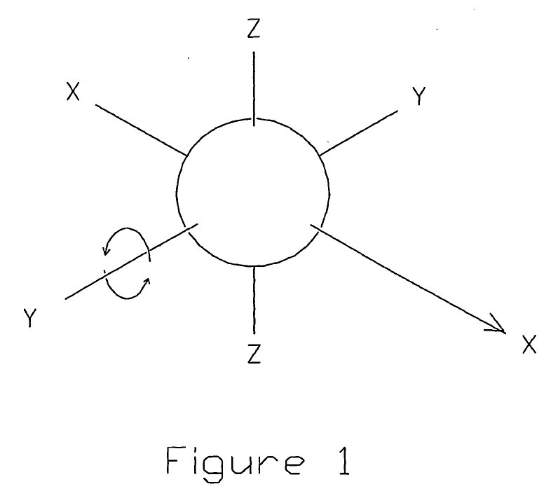

FIG. 1 shows an isometric view of a ball with mutually orthogonal axes X-X, Y-Y and Z-Z passing through its centre. The ball is moving in a linear direction, parallel to axis X-X and in the direction indicated by the arrow head. The ball is also spinning about Y-Y, in an anticlockwise direction as viewed in the figure.

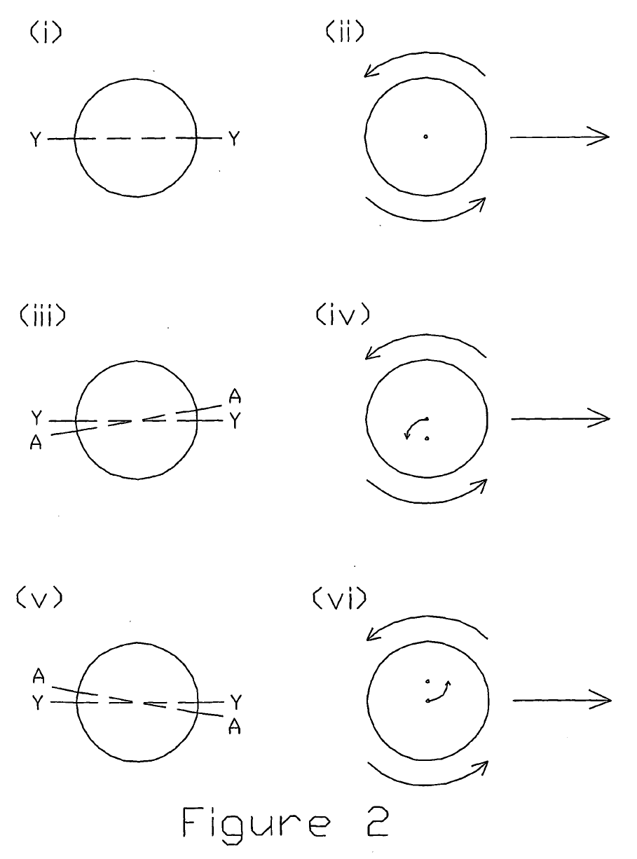

FIG. 2 shows several views of a ball which is spinning and moving linearly. View (i) represents a front view of the ball shown in FIG. 1, as viewed along direction X-X. View (iii) represents a view similar to view (i), except that in this instance the ball is spinning about an axis A-A, which is in the same plane as Y-Y and Z-Z. A-A also passes through the centre of the ball, but is tilted at an angle to Y-Y. View (v) is similar to view (iii), except that in this instance A-A is tilted in the reverse direction. The axes Y-Y and A-A are shown as dashed lines where they pass through the interior of the ball. Views (ii), (iv) and (vi) represent side views of the same balls shown in views (i), (iii) and (v), respectively, viewed along direction Y-Y from left to right in the figure. Views (iv) and (vi) also show the locus of a point on the surface of the ball, which commences at the intersection of Y-Y and the surface, as the ball rotates through a quarter turn about A-A.

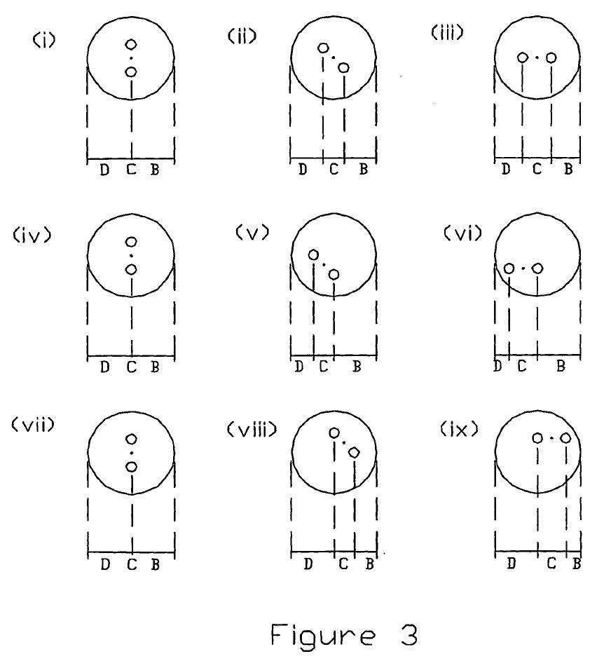

FIG. 3 shows side views of a ball similar to that shown in FIG. 2. The ball is provided with marking comprising two circular marks on its surface, which are symmetrically disposed about an imaginary point corresponding to the point where the Y-Y axis intersects the surface prior to the ball being struck. The balls commence in a position where the marks are disposed on a vertical axis which is orthogonal to the direction of movement. The imaginary point is also shown in the views. FIGS. 3 (i), 3 (ii) and 3 (iii) show progressive views of a ball which is struck from a stationary position and which executes a 45° and 90° backspin without any sidespin component. FIGS. 3 (iv), 3 (v) and 3 (vi) show progressive views of a ball which is struck from a stationary position and which executes a 45° and 90° backspin with a slicing sidespin component. FIGS. 3 (vii), 3 (viii) and 3 (ix) show progressive views of a ball which is struck from a stationary position and which executes a 45° and 90° backspin with a hooking sidespin component. The figure also shows distances between the centres of the marks and the leading and trailing edges of the ball projected onto a horizontal axis.

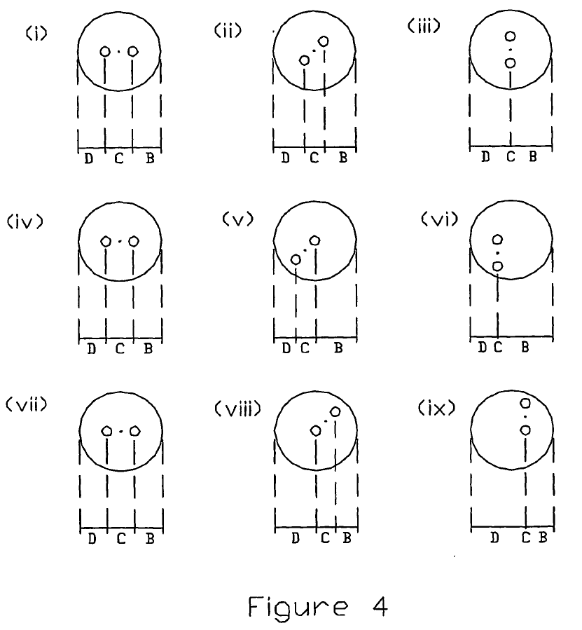

FIG. 4 shows similar views to FIG. 3, except that in this instance the balls commence in a position where the marks are disposed on an axis which is horizontal and parallel to the direction of movement.

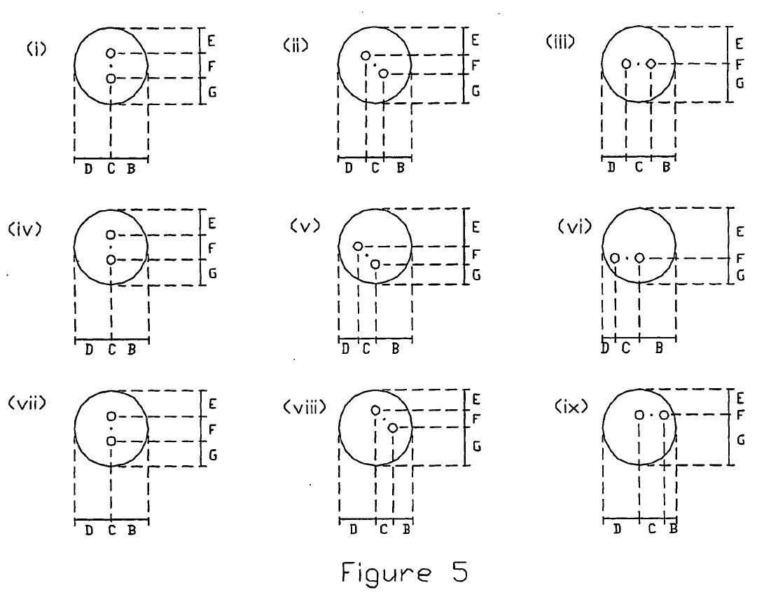

FIG. 5 shows identical views to FIG. 3, and additionally shows also distances between the centres of the marks and the upper and lower edges of the ball projected onto a vertical axis.

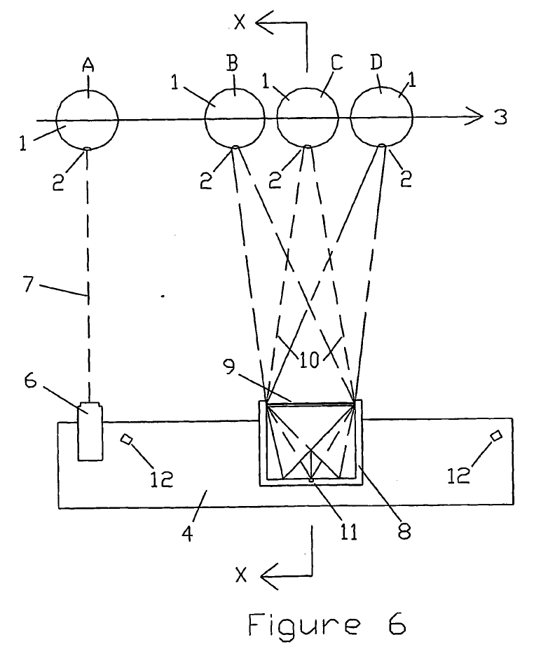

FIG. 6 shows a diagrammatic plan view of an apparatus for measuring the spin characteristics of a golf ball struck by a club. The view shows an initial starting position of a ball at A, and three further views of the ball at B, C and D as it passes a detection means, together with heat rays from a mark on the ball. The view also shows a marking means. To facilitate explanation, the sizes of balls and components of the apparatus are shown on an exaggerated scale in FIGS. 6 to 10.

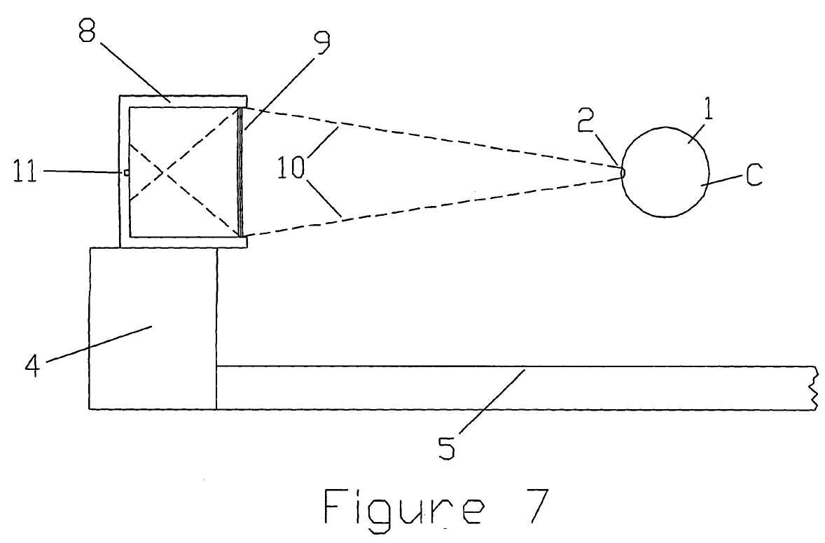

FIG. 7 shows a diagrammatic side section across X-X of the view shown in FIG. 6, with the ball shown in position C. The marking means is omitted from this view.

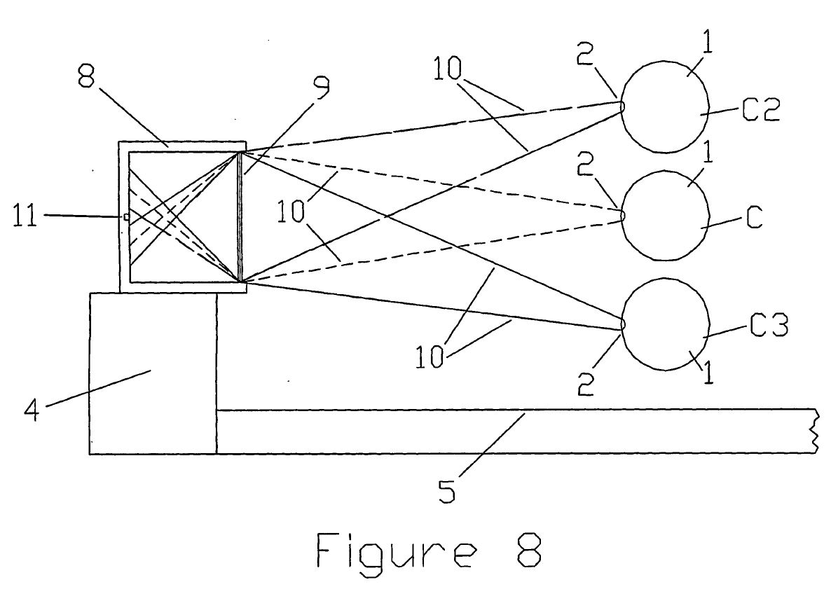

FIG. 8 is similar to FIG. 7, but additionally shows a ball at a higher position C2 and a lower position C3.

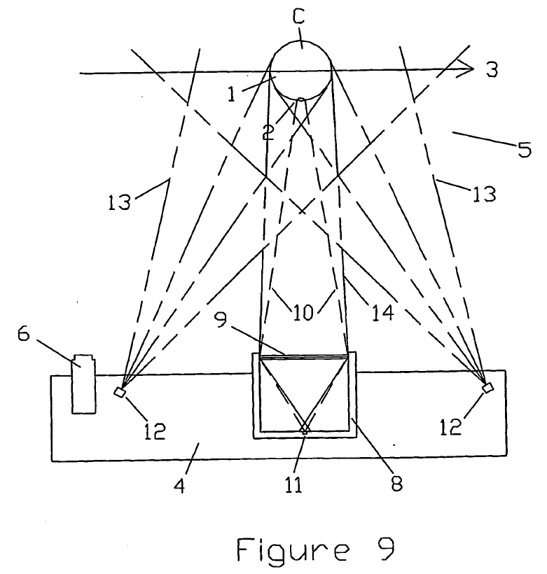

FIG. 9 shows a diagrammatic plan view, similar to FIG. 6, with the ball shown in position C, together with heat rays from the mark on the ball. The view also shows two ball radiation emitters, together with their emitted rays and rays reflected by the ball.

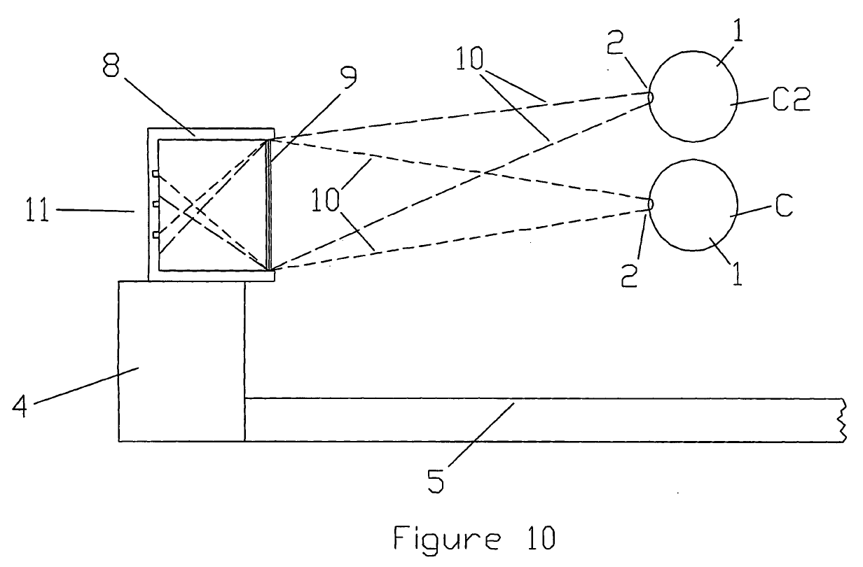

FIG. 10 shows a diagrammatic side section view, similar to FIGS. 7 and 8, with the ball shown in position C and also in an alternative position C2, which is higher than position C. This view also shows a detection means with three heat sensors, disposed along a substantially vertical axis.

Referring now to FIG. 1, and views (i) and (ii) of FIG. 2, these show a ball with mutually orthogonal axes X-X, Y-Y and Z-Z passing through its centre. The ball is moving parallel to X-X in the direction indicated by the arrow head. The ball is also spinning about Y-Y, in an anticlockwise direction as viewed in the figures. The conditions may be equated to the launch of a typical golf shot which has been hit without sidespin. Axis Y-Y is horizontal and axis X-X close to horizontal, but tilted up by the launch angle. Axis Z-Z is close to vertical, but tilted back orthogonal to X-X. The ball displays significant backspin about Y-Y, principally resulting from the lofted face of the club hitting the ball below centre. The ball displays no sidespin about Z-Z and no rifle spin about X-X.

A view of the moving ball, along direction Y-Y, will show no movement of the point on the surface which intersects axis Y-Y, although the surrounding surface region will rotate about the point. Thus an observer or sensing means monitoring view (ii) of FIG. 2 from direction Y-Y, would find that the point remains at the centre position of the ball throughout the ball's flight.

Referring now to views (iii) and (iv) of FIG. 2, these show a ball which is rotating about a tilted axis A-A, as would occur with a ball with a clockwise sidespin component, as seen in plan view, causing it to veer to the right. This type of shot is referred to as a sliced or slicing shot when executed by a right handed golfer. The original point on the surface, intersected by the Y-Y axis, will now orbit the point on the surface intersected by the axis of rotation A-A, describing a circular locus. View (iv) shows the locus which occurs over the first quarter turn of the ball about axis A-A. It can be seen that the movement is initially backwards and then gradually downwards, relative to the outline perimeter of the ball.

Referring now to views (v) and (vi) of FIG. 2, these show a ball which is rotating about an axis A-A which is tilted in the reverse direction of that shown in views (iii) and (iv), as would occur with a ball with an anticlockwise sidespin component, as seen in plan view, causing it to veer to the left. This type of shot is referred to as a hooked or hooking shot when executed by a right handed golfer. The original point on the surface, intersected by the Y-Y axis, will again orbit the point on the surface intersected by the axis of rotation A-A, describing a circular locus. View (vi) shows the locus which occurs over the first quarter turn of the ball about axis A-A. It can be seen that the movement is Initially forwards and then gradually upwards relative to the outline perimeter of the ball.

It can be seen from the above that the view of the original point, as seen by an observer or sensing means in side view, will move in a unique way for each combination of back spin and side spin. In one example of the invention, the ball is provided with one or more marks which allow this movement to be detected and measured by a measuring means.

One aspect of the invention relates to an insight that the sidespin and backspin characteristics of a ball can be determined in a substantially one dimensional manner where a mark on a moving ball is monitored in one direction, such as a side view direction.

FIG. 3 shows side views of a ball similar to that shown in FIG. 2. The ball Is provided with two circular marks on its surface, which are symmetrically disposed about an imaginary point corresponding to the point where the Y-Y axis intersects the surface prior to the ball being struck. The views also show the imaginary mark. FIGS. 3 (i), 3 (ii) and 3 (iii) show progressive views of a ball which is struck from a stationary position and which executes a 45° and 90° backspin without any sidespin component. FIGS. 3 (iv), 3 (v) and 3 (vi) show progressive views of a ball which is struck from a stationary position and which executes a 45° and 90° backspin with a slicing sidespin component. FIGS. 3 (vii), 3 (viii) and 3 (ix) show progressive views of a ball which is struck from a stationary position and which executes a 45° and 90° backspin with a hooking sidespin component.

Each view also shows distance B which is the projected distance onto a horizontal axis from the leading edge of the ball to the centre of the first mark or leading mark, distance C which is the projected distance between the centres of the two marks, and distance D which is the projected distance from the centre of the second mark to the trailing edge of the ball.

In each view, the distances are projected onto a single dimension, which in this instance is the horizontal direction and direction of linear motion of the ball.

It will be appreciated from FIG. 3 that a ball without side spin will be characterised by equal distances B and D, since the axis of rotation remains at the centre of the perimeter as viewed in these side views. Where a ball displays slicing side spin, distance B will be greater than distance D, the difference increasing for increasing degrees of sidespin. Similarly, where a ball display hooking sidespin, distance B will be less than distance D, the difference increasing for increasing degrees of sidespin.

It will also be appreciated that the amount of back spin which occurs over the first quarter turn is directly related to distance C, which gradually increases as the ball rotates. Where a determination is made of the amount of back spin which occurs over a specific period of time, geometric allowance must be made for the curved surface of the ball, which alters the distances in a known consistent manner.

The values or relative values of the distances between marks and object features, shown as projected dimensions B, C and D in FIG. 3, can be determined by recording the times at which marks and object features on the moving ball or object cross a reference or boundary, such as a plane of detection of a detection means which monitors the object in a side view such as that those shown in FIG. 3. Where the object is moving at constant linear speed, the projected distances between marks and object features will be directly proportional to the durations or differences in recorded times between the events of the marks or object features crossing the reference or boundary, with due allowance being made, if necessary, for any movement component due to spin. The event of crossing the reference or boundary may be recorded in various ways, including recording the entry or exit of the mark or object feature at the reference or boundary, or some aspect of its passage across the reference or boundary, for example, a determination of the crossing of the centre of a mark across the centre of a reference or boundary.

The values of the distances can be analysed by comparing them to a reference or second set of values. In one example, they may be compared to a set of known values for the marks or object features at a previous point in time, such as a known starting position for the object. In a second example, two sets of values may be determined at different references or boundaries.

The reference or boundary may comprise a plane or two dimensional region across which the object moves. Where the object moves on a trajectory in the earth's gravitational field, its movement will substantially be in a vertical plane and the reference or boundary may comprise a plane or two dimensional region which is substantially orthogonal to the actual or intended plane in which the object moves. The intended plane refers to the plane which comprises the locus of the intended direction. The intended direction refers to the typical, expected or desired direction of movement of the object, which may differ from the actual movement. Where an apparatus is constructed to measure the spin characteristics of an object which may execute some degree of unpredictability in its actual movement, it will usually be arranged such that it is orientated to measure movement in the typical, expected or desired plane. Where the object moves on a trajectory in the earth's gravitational field, it will also frequently be found convenient to use a reference or boundary which comprises a plane or two dimensional region which is substantially orthogonal to the actual or intended plane in which the object moves and is also vertical. Where the reference or boundary plane is views as a plane containing two mutually orthogonal axes, to optimise measuring accuracy, it is preferable that one of these axes be orthogonal to the intended or actual direction of motion of the object, and the other axes be at an angle not exceeding an acute angle to the intended or actual direction of motion of the object, and preferably orthogonal or close to orthogonal.

In FIG. 3, the distances in each view are projected onto a single dimension, which in this instance is the horizontal direction which is also the linear direction of motion of the ball. The term single dimension refers to a one-dimensioned direction or value, rather than a two-dimensioned or three-dimensioned direction or value as would conventionally be applied to spin motion characteristics.

As shown in FIG. 3, projected marks or object features may be advantageously detected or measured in a side-view which is substantially orthogonal to the axis of back spin or forward spin. Forward spin is spin about the same axis as back spin, but in the opposite direction of rotation. It can be appreciated from the figure that measurement or detection of spin characteristics is associated with changes in the projected distance, or distance, between marks or object features between two such side-views. It can also be appreciated that measurement or detection of back spin or forward spin characteristics is associated with changes in the projected distance between marks or between object features. It can further be appreciated that measurement or detection of side spin characteristics is associated with changes in the projected distance between marks and object features.

FIGS. 3(i), 3(iv) and 3(vii) depict an object in a known or starting position, where marking comprises two marks which are disposed symmetrically about the centre of the side-view and are disposed on an axis which is substantially orthogonal to the direction of the single dimension and the intended direction, and marks or object features are projected in a direction parallel to the single dimension and the intended direction.

It can also be appreciated from FIG. 3 that where measurement is taken within the first quarter turn of back spin or forward spin, progressively increased side spin is associated with increased difference between the projected distance between leading edge and first mark and the projected distance between the trailing edge and the second mark and absence of difference between these projected distances is associated with absence of side spin. It can also be seen that slicing side spin is associated with the projected distance between the leading edge and the first mark being greater than the projected distance between the trailing edge and the second mark, as shown in FIGS. 3(iv), 3(v) and 3(vi), and hooking side spin is associated with the projected distance between the leading edge and the first mark being greater than the projected distance between the trailing edge and the second mark, as shown in FIGS. 3(vii), 3(viii) and 3(ix). It can also be appreciated that progressively increased back spin or forward spin is associated with increased projected distance between marks, and absence of back spin or forward spin is associated with the projected distance between marks remaining substantially unchanged.

FIG. 4 depicts objects moving with spin characteristics which are the same as those in the equivalent views in FIG. 3, but in this instance the two marks are disposed on an axis which is substantially parallel to the single dimension and the intended direction in the known or starting position. The projected distances change in a broadly similar manner where measurement is taken over the first quarter turn of back spin or forward spin, other than that progressively increased back spin or forward spin is associated with decreased projected distance between marks. However, distances between marks and object features, where side spin is present, develop in a more pronounced manner where the marks are disposed on an axis which is orthogonal to the direction of the single dimension, as depicted in FIG. 3, with more accentuated differences between the values of B and D. Accordingly, it will usually be found advantageous to dispose the marks on an axis which is substantially orthogonal rather than parallel to the single dimension or intended direction.

FIG. 5 shows identical views to FIG. 3, and additionally shows also distances between the centres of the marks and the upper and lower edges of the ball projected onto a vertical axis. It can be seen that quite similar information on spin characteristics can be obtained from a projection of marks and object features onto a vertical axis. In this instance, the relevant object features are the sides of the perimeter of the object. It can be observed that distances E, F and G and their relative relationships in FIG. 5 indicate similar spin characteristics to distances B, C and D and their relative relationships In FIG. 4, respectively.

It will be appreciated from FIG. 3, that the projected dimensions will no longer have unique values when the object describes more than a quarter turn of back spin or forward spin. For example, the projected dimensions will be repeated every half turn where the object has no side spin, and will become ambiguous where side spin is present. This ambiguity can be overcome by providing additional marks on the ball where measurement is taken across more than one quarter turn of back spin or forward spin.

Marking comprises regions on the surface of the object which are detectable. In the example depicted in FIG. 3, marking comprises two detectable marks which are of substantially circular shape and are relatively small compared to the size of the object. For example, marks of diameter of about 3-5 mm may be used on a golf ball which has a diameter of about 42 mm, the mark thus having an area of less than 3% of the projected side view area of the ball. If the marks are produced as circular shapes on the spherical surface, their shape will be somewhat distorted when seen in side view, but will remain substantially circular in shape. Marks of this type have various detection advantages, particularly when detected in projected positions. In particular, the position or centre of the mark may be identified by detection of its leading and trailing edges, or detection of its upper and lower side edges. The circular mark also has the advantage of retaining a substantially constant projected magnitude as the object rotates.

The projected detection or measurement of marks or object features in a single dimension can be achieved in various ways and the depictions shown in FIGS. 3, 4 and 5 are diagrammatic. Projection may first occur during detection or may first occur during subsequent measurement. In a preferred aspect of the present invention, marks or object features, or projected marks or projected object features, are detected or measured by anamorphic detection or measurement. By anamorphic detection or measurement is meant detection or measurement which is associated with different magnification on two axis which are disposed at angles to each other, including angles which are mutually orthogonal. One of these axes is referred to as the magnification axis and the other is referred to as the compression axis. The magnification axis has positive magnification relative to the compression axis and the compression axis has negative magnification relative to the magnification axis. The projection depicted in FIGS. 3 to 5 is an example of anamorphic detection or measurement where one axis remains unchanged and the other axis is totally compressed.

In a preferred embodiment of the invention, where the object is a golf ball struck by a golf club, marking comprises a region on the surface of the object which is at a detectably different temperature to an adjacent region of the surface. The marking means is operable to produce temporary heat marking on the surface of the object. The detection means includes a heat sensor and is operable to detect a region on the surface of the object which is at a detectably different temperature to an adjacent region of the surface.

Marking on the surface of the ball comprises two substantially circular marks, such as those shown in FIG. 3, and is created by heating the surface while the ball is in a stationary position prior to being struck. Such marks and marking shall be referred to as heat marks. Heat marks may be applied shortly before the strike such that there is insufficient time for appreciable side conduction of heat outwards from their perimeters. The marks are remote from that portion of the ball which is contacted by the face of the club. The heat marks are not visible, but radiate heat which can be detected by heat sensors in a detecting means.

The use of heat marks has several very significant advantages where golf ball spin is measured. Firstly, it allows use of standard golf balls. This is convenient for the player and also allows all types of balls to be used with the apparatus. Secondly, it obviates the need for the player to position the ball in a particular orientation prior to the shot, as would be necessary with a ball with permanent marks. This also obviates the possibility of the ball being incorrectly positioned. Thirdly, it avoids the use of a ball which is always struck about a single equator. Continued striking of a ball about a single equator or at the same region could give rise to selective progressive local breakdown or distortion of the structure of the ball which would not occur in real play. Golf balls typically comprise compound materials with fillers, where adhesion between the components of the material can progressively break down.

Although the radiation exchange between two bodies at different temperatures is related to the difference in the fourth power of the absolute temperatures of the two bodies, the relationship between radiation flux and heat mark temperature is closer to a linear relationship over the temperature range which is feasible for a golf apparatus operating at normal ambient temperatures. The required temperature of the heat mark above the ambient temperature of the ball will depend on the type of heat sensing system which is used. With a well designed detection means, a temperature difference of about 20° Celsius may be used. A temperature difference of this value is relatively easy to produce and will not pose any hazard to the player or the ball.

A more detailed embodiment of the invention shall now be described, by way of example.

FIGS. 6 and 7 show diagrammatic plan and side section views of an apparatus for measuring the spin characteristics of a golf ball struck by a club. The apparatus comprises a marking means, a measurement means, an object feature radiation emitter means, a playing surface and a support means. The measurement means includes a detection means and a computing means. The computing means is not shown in the figures. To facilitate explanation, the sizes of balls and components of the apparatus are shown on an exaggerated scale in FIGS. 6 to 10.

Referring again to FIGS. 6 and 7, the ball is placed in a defined position on the playing surface, or on a tee above the playing surface, and the player strikes the ball in a direction from left to right, as viewed in the figure. FIG. 6 shows the initial starting position of the ball at A, and the direction of linear movement of the ball when the ball has been struck, shown by the arrow passing through the centre of the ball.

The ball is marked with two heat marks by a beam which impinges on its surface, prior to the ball being struck by the club. The marks are relatively small circular marks, symmetrically disposed about the centre of the side view, one above the other, substantially the same as those shown in FIG. 3 and described earlier. However, to simplify the depiction of heat rays emitted from the marks, just one central mark is shown on the ball in FIGS. 6-10.

FIG. 6 shows three further views of the ball at B, C and D as it passes the detection means, together with those heat rays from the marks on the ball which fall on the lens of the detection means. FIG. 7 shows a view of the ball at C. The rays from the marks at positions B, C and D are depicted as lines with long dashes, short dashes and mixed dashes, respectively.

The detection means comprises a detection means housing, with an anamorphic lens on the side facing the path of the ball, and a heat sensor internally mounted at the rear of the housing. The anamorphic lens has different rates of magnification on different axes. The lens is arranged with one of these axes horizontal and the other vertical. As shown in FIG. 6, heat rays from the heat mark are compressed in the horizontal plane, forming an image which is proportionately narrower in width than the heat mark in the planar region at which the heat sensor is mounted. As shown in FIG. 7, heat rays from the heat mark are stretched in the vertical plane, forming an image which is proportionately much greater in height than the heat mark.

The overall formed image is a narrow inverted vertical bar. As the ball moves from position B to C to D, the narrow vertical image traverses the planar region in which the heat sensor is mounted, in the opposite direction to that of the ball, momentarily impinging on the heat sensor at position C. The reference or boundary across which the mark is being detected corresponds to the planar region containing the mark, the heat sensor and the relevant axis of the anamorphic lens, which is its vertical axis.

This method of detection provides several important advantages. It provides a means for collecting energy over an area much larger than the entry window of the heat sensor, with energy being collected over an area equal to the face of the lens. The narrow width of the image ensures that the heat sensor only detects the heat spot when it is at one narrowly defined point of its motion, corresponding to position C in the figures. The proportionately greater height of the image allows the image to be detected over a range of elevations of the ball.

It is noted that this format of image detection corresponds to projected detection or measurement of marks in a single dimension, as depicted in FIG. 3, in this instance the single dimension corresponding to the horizontal axis of the anamorphic prism.

Referring now to FIG. 8, this is similar to FIG. 7, but additionally shows a ball at a higher position C2 and a lower position C3. The rays from the marks at positions C, C2 and C3 are depicted as lines with short dashes, lines with mixed dashes and continuous lines, respectively. It can be appreciated from the FIG. 8 that the images of the heat mark in all three ball positions impinge on the heat sensor, thus advantageously allowing detection over a range of elevations of the ball.

The heat detection means is set a sufficient distance from the flight path of the ball and club to obviate the risk of being struck with the ball or club and to provide minimal visual obtrusiveness for the player. Usually it will be found advantageous to locate the heat detection means on the opposite side of the ball to the player.

Particular care must be taken in the selection and arrangement of heat sensor due to the high speed of the ball and consequent short period over which the heat detection means is subject to the radiation signal. The formats of heat sensors which are most commonly available will be unable to detect heat marks at typical speeds at which golf balls travel. However, with suitable preparation, heat sensors can be produced which are operable to measure high speed heat marks. Furthermore, such heat sensors can be mass produced at low unit cost. Heat sensors operate in various ways and examples from different categories can potentially satisfy the requirements of the apparatus. A few of these are briefly discussed below.

Pyroelectric heat sensors measure changes in infrared radiation emitted by warm objects and their electrical output is a function of the rate of change in temperature. The entry and departure of the heat mark across the field of view of the heat sensor provides a very high rate of change, and provides the potential for advantageously high sensitivity with relatively low heat mark temperature. Commercially available pyroelectric sensors are almost always configured to operate in voltage mode in which they display relatively slow response time which are completely unsuited for measuring high speed heat marks. However this type of sensor is well suited to heat mark detection when configured to operate in current mode.

Photoconductive heat sensors operate by detection of heat energy rather than the rate of change of temperature, and can be arranged to measure high speed heat marks. Examples of such sensors include lead-selenide sensors, indium-selenide sensors and mercury-cadmium-telluride sensors.

In the preferred embodiment, the measurement means is operable to measure the relative intensity of the heat radiation signal, in addition to detecting its simple presence or absence. Most heat sensors, including all of the types mentioned above, are capable of providing an output which varies with the intensity of the detected heat radiation signal, and can therefore be used in a measurement means to measure the relative intensity.

Sensors may be provided as single or dual element types. In the case of a dual element pyroelectric sensor, the elements are arranged side-by-side, typically substantially parallel to the intended direction of motion. The sensing elements are typically connected in series opposition such that their outputs subtract one from the other. Any signal common to both elements is advantageously cancelled in this arrangement. Where a relatively warm object, such as a heat mark, passes in front of the sensor, it first activates one of the elements and then the other, while background signals, vibration and the effects of ambient temperature affect both elements simultaneously and are thereby cancelled. The use of a differential signal also causes the output to be effectively amplified. The physical arrangement of the two elements allows for maximum sensitivity along a direction crossing the two elements sequentially.

The heat sensor may be provided with a filter which preferentially transmits radiation of the type which is emitted by the heat mark but minimises unwanted wavelengths, such as those occurring from visible light. The filter may intercept the heat beams at any convenience position in the heat detection means. The filter range is advantageously matched to the characteristic range of wavelengths which are predominantly emitted at the temperature range of the heat mark on the ball surface.

An anamorphic lens with the required optical properties can be arranged in various ways, including a combination of spherical lens characteristics and cylinder lens characteristics. The general effect of the cylinder lens characteristic is to change the focal lengths, and therefore the magnification powers, of the combination such that the focal length parallel to the axis of the cylinder differs from that which is orthogonal to it. The two lens characteristics may be combined into a compound lens characteristic which is referred to as toroidal.

The anamorphic lens can be conveniently produced as a Fresnel lens comprising appropriate facets. The relatively small thickness of the Fresnel lens allows it to be produced as a low cost one stage polymer injection moulding, or as a hot impressed polymer injection moulding. A polymer material is used which has high translucency for the wavelengths emitted at the temperature range of the heat mark.

In an alternative embodiment, the anamorphic lens is replaced by an off-axis anamorphic reflector. This can also be produced as a low-cost Fresnel faceted polymer component, the reflecting surface being metallised to provide high reflectivity. The anamorphic reflector operates in a similar manner to the anamorphic lens, differing in that the rays are reflected back onto the heat sensor. The reflector surface is arranged off-axis to allow the heat sensor to be positioned out of the way of the incoming rays.

In a further alternative embodiment, the detection means includes a screening means which is operable to exclude from detection emission signals from the marks or object features, other than those generated at or close to the reference or boundary region. The screening means may comprise a slot, spaced apart from the heat sensor, and disposed on the ball side of the heat sensor. The slot is disposed parallel to the plane of the reference or boundary, with its screening edges close to each side of the planar region of the reference or boundary. Where the heat sensor has very high sensitivity to the heat mark radiation, it may be possible to use the screening means without need to concentrate or focus the heat mark radiation. Otherwise a lens or reflector may be provided to concentrate the radiation signals which enter the slot.

The measurement means is also operable to detect or measure object features by detection of reflected radiation from the object. The apparatus includes an object feature radiation emitting means which is operable to subject the object to a beam of radiation.

Referring now to FIG. 9, this shows a diagrammatic plan view, similar to FIG. 6, with the ball shown in position C, together with heat rays from the mark on the ball. The view also shows two object feature radiation emitters, together with their emitted rays and those reflected by the ball onto the detection means. Rays emitted by the heat mark are depicted as lines with short dashes, and rays reflected by the object or ball are depicted as lines with mixed dashes. As before, the heat mark results in an image shaped as a narrow vertical bar. The ball results in an image shaped as a broader vertical bar.

As the ball enters and passes position C, the leading side of the ball reflected image, the heat mark emitted images and the trailing edge of the ball reflected image, sequentially cross the heat sensor. The measurement means records the times of these events and uses them to determine the spin characteristics. This type of image detection is an anamorphic detection and corresponds to the projected detection or measurement of object features and marks in a single dimension.

In addition to providing a simple and convenient method for measuring object features, the method is advantageous in that it uses the same detection elements to measure object features and heat marks, thereby comparing like-with-like and eliminating potential inaccuracies which might otherwise arise from the use of different detection elements.

Although substantially vertical, the edges of the heat mark or ball images may be slightly curved, due to the images resulting from the stretching and compressing of circular shapes. Any significant potential error arising from the images having edges which are not quite straight and parallel are compensated in the computing means or compensated by providing a plurality of heat detectors, as will be discussed later. Methods for compensation in the computing means include application of the known regular outline shapes of the heat marks and ball to the detection of their leading and trailing edges.

The object feature radiation emitting means emit beams of pulsed radiation which the measurement means is operable to selectively detect and measure. This assists the measurement means in distinguishing between signals reflected from the object features and those emitted from the heat marks. It also assists the measurement means in distinguishing signals originating from the radiation emitting means and those due to ambient radiation.

Two object feature radiation emitting means, one obliquely ahead and one obliquely behind the ball, are used in order to increase the proportions of radiation which fall on the leading and trailing sides of the ball as it passes through the reference or boundary region. They emit beams of simultaneously pulsed radiation. A single centrally positioned radiating emitting means would give rise to a very strong reflected signal on the centre of the ball where it was not required, and which could affect the detection of the leading and trailing edges. The object feature radiating emitting means may comprise pulsed infrared LEDs.

In an alternative embodiment, the measurement means is operable to detect or measure heat radiation emitted by object features at a wavelength or temperature different to the wavelengths or temperatures of the marks. Where the detection means is very sensitive and the ball is at a different temperature to the background region adjacent the reference or boundary, the heat sensor may be operable to detect the leading and trailing edges of the ball without any requirement for radiation emitting means.

The detection means includes a plurality of heat sensors located along an axis which is disposed at an angle to the intended direction and which is a substantially vertical axis in the preferred embodiment. The measurement means is operable to detect or measure the location of marks in a vertical direction using detected or measured differences in detection of marks or object features at the plurality of locations along the axis.

Referring now to FIG. 10, this shows a diagrammatic side section view, similar to FIGS. 7 and 8, with the ball shown again in position C and also in an alternative position C2, which is higher than position C. The figure also shows a detection means with three heat sensors, disposed one above the other. Rays from the marks at positions C and C2 are depicted as lines with short dashes and long dashes, respectively.

The vertical bar images of the marks will vary in intensity, principally due to their resulting from the distortion of shapes which were originally circular. Emitted radiation from the bar will be most intense at the centre and will gradually reduce in intensity towards each end. The heat sensors and the measurement means are arranged such that the relative strength of the signal is detected and measured. It will thus be appreciated from FIG. 10 that the image of the heat mark at position C is detected most strongly by the central heat sensor and detected relatively weakly by the upper and lower heat sensors. The heat mark at position C2 is not detected by the upper heat sensor at all, and is detected a little more strongly by the lower heat sensor than by the central heat sensor. It will therefore be appreciated that different relative vertical positions of the heat mark will give rise to different sets of relative readings at the heat sensors and that the measurement means may therefore be arranged operable to determine the vertical height of the heat mark by detecting the relative strengths of the radiation signals as the heat mark traverses the detection means. The vertical heights of the object features, which in this case are the top and bottom of the ball, may also be determined in a similar manner by determination of the relative intensities of the ball image bar at the different heat sensors. This format of image detection again corresponds to projected detection or measurement of marks in a single dimension, in this instance the single dimension corresponding to the vertical axis of the anamorphic prism.

Measurement of the marks and object features, projected onto the vertical axis, may be used to determine the spin characteristics in a manner which is the same or similar to that which was previously mentioned and depicted in FIG. 5. The measurements may be used in conjunction with measurements of spin characteristics determined by projection onto the horizontal axis. The relative accuracies resulting from projection on a horizontal or vertical axis will depend on the characteristics of the measurement means. The most appropriate choice of axis and resulting measurement, or most appropriate combination of measurements, may be determined by trial.

The use of a plurality of heat sensors disposed on a vertical axis provides several other advantages. It allows detection over a greater range of vertical heights, as can be appreciated from observation of FIG. 10, ensuring that heat signals will be sufficiently well focused on at least one heat sensor. It also allows more accurate detection of the vertical image bars, allowing the measurement means to readily compensate for any curvature of the vertical edges of the image bars.

The number of heat sensors in these arrangement may vary from two upwards. Accuracy and range will tend to increase with greater numbers of heat sensor, which must be balanced against increasing cost. Although FIG. 10 shows the three sensors being disposed along a straight vertical line, in reality the positions of the sensors will be determined by the optical focus plane of the anamorphic lens, and the sensors will ideally be disposed along a slightly curved line which lies in a vertical plane.

In an optional arrangement, the heat sensor may comprise a slot sensor with its long axis orientated parallel with the anamorphic axis of the arrangement. A slot sensor is a sensor with a detection window which has a long and a short axis. The slot sensor may be used to anamorphically detect a natural image of the heat mark or object feature, but is preferably used in conjunction with an anamorphic lens, where it accentuates the anamorphic benefits.

FIGS. 6 to 10 show the apparatus with a single detection means which is located approximately 150 mm from the starting tee position. This will allow the ball to execute about 45° of backspin where a typical drive backspin rate of 50 RPS occurs. This arrangement requires the apparatus to be operable to determine the time of impact at the starting position.

Optionally, the apparatus may be provided with a plurality of detection means. The detected signals from the plurality of detection means are processed by a common computing means. The apparatus may otherwise be very similar to that which has already been described. The detection means are positioned at different distances or elevations from the starting position, appropriate to the types of shots which are required to be measured. Although the provision of a plurality of detection means will increase the cost and complexity of the apparatus, it can provide several advantages. It can allow spin characteristics to be measured across a wider range of shots. It can allow more accurate measurement by selectively using measurements between events where greater spin has occurred. It can allow the controller to identify very high backspin conditions where the backspin might otherwise have problematically exceeded 90°. It can assist in obviating potential errors related to the accelerated movement in the period immediately following impact from the starting position. It can obviate the requirement for the apparatus to detect the time of impact at the starting position.

The computing means and measurement means are operable to record the times when each detection event occurs and determine the spin characteristics from them. The ball is briefly accelerated from the starting position, typically moving about 12 mm in a little less than 0.005 seconds. Once it ceases to be in contact with the club face, it no longer accelerates and moves at substantially constant speed past the detection means. Means are provided to detect the time of impact and the computing means is programmed to make due allowance for the initial period of acceleration. Since the time and positions of the marks and object features are known at the starting position and are also known at the reference or boundary at the detection means, the relevant distances can be determined by the computing means. These distances are equivalent to, or related to, B, C and D in FIGS. 3-5, and E, F and G in FIG. 5. The computing means determines the spin characteristics from these distances by methods similar or equivalent to those discussed earlier in this specification. The computing means is also operable to make necessary adjustments to distances arising from the curvature of the surface of the ball, since the geometry is a hemisphere of known diameter. The computing means is also operable to make any other necessary adjustments or compensations, as appropriate. The computing means may comprise an appropriately programmed electronic processor or computer, or combination of processor and computer.

The computing means may additionally comprise an artificial neural-type intelligence means, which has been previously trained or programmed with information relating to a wide range of ball spin movement characteristics. By artificial neural-type intelligence means is meant, determination or problem solving means, which operates in a manner which has similarities to human determination or problem solving. In particular, this type of determination of problem solving relates to previously learned experience from which a solution can be determined or interpolated when a new problem or situation arises. Where an artificial neural-type intelligence means is used, it will usually be advantageous to pre-process some or all of the primary heat detector signals before presenting them to the neural means and weigh their relative importance to particular types of outputs. This pre-processing stage may be carried out by conventional electronic processing methods and devices.

The apparatus includes a marking means which is operable to produce the required heat marking or heat marks on the surface of the golf ball. Heat marking may be achieved in various ways.

In one embodiment, heat marking is achieved by conductive heat transfer. In one example, a ball feed means employs fingers which pick the ball from a position away from the tee or starting position, move it to the tee, release it and return to the position away from the tee. The fingers include heated contact pads which transfer the appropriate heat marks to the surface of the ball.

In an alternative embodiment, heat marking is achieved by a marking means which directs appropriately shaped beams of radiation onto the surface of the ball, to create heat marks with sharply defined edges. This may be achieved in various ways. In one example, beams of highly collimated infrared radiation are directed onto the surface of the ball, using laser diode sources. In another example, lenses are used to focus heat marks onto the surface of the ball, using infrared radiation LED or incandescent lamp sources. The marking means is positioned away from the playing surface, as depicted in FIG. 6.

Where the marking means comprises a radiation emitting means, radiation is emitted at wavelengths at which the object has relatively high radiation absorptivity. The white surface of the golf ball will be found to have very poor absorptivity with wavelengths such as occur in visible light, but will have increasingly higher absorptivity as wavelength increases and moves further into the infrared region. An absorptivity of greater than 0.85 can be fairly easily achieved with the types of organic materials which typically comprise the cover and coating of a golf ball.

In one embodiment where radiation emitting means are used, the apparatus is operable to detect the commencement of the player's swing, or the presence of the player in the swing position, and switches on the beams which heat the heat mark. This will allow about two seconds or more to raise the heat mark to the required temperature. The apparatus may also be provided with a remote heat sensor which monitors the temperature of the heat mark and modulates the beam to prevent the temperature exceeding the required temperature. In an alternative embodiment of the invention, the apparatus is operable to detect the rapid downswing of the club head in the region where the downswing takes place. A thin uppermost surface region of the ball is very rapidly heated when the apparatus senses this rapid downswing. The ball is struck very quickly after this heating takes place and the required heat mark detection takes place before the thin heated surface cools appreciably. This has several safety advantages. It may allow high transient surface temperatures to be safely used, partly because the temperature of the heat marks will decay rapidly and will have returned to near ambient temperature if touched shortly after being heated, and partly because the heat capacity of the shallow heat mark is small and unlikely to cause injury even if touched shortly after being heated. Furthermore, since the heat source is triggered by the rapidly moving club head, it potentially obviates the possibility of the heat source or the ball being touched during the heating process or immediately afterwards.

Where radiation emitting means are used, the marking means may include checking means which allow the player to check that heat marks are correctly positioned on the ball. In one example, an annular beam of visible light, which is physically locked in alignment with the invisible hear radiation, is directed towards the ball. The annular beam is shaped such that it falls just outside the perimeter of the ball when the heat marks are correctly positioned. A positioning error is detected where any part of the annular beam falls on the surface of the ball. The marking means is provided with adjustment means which allows correction of any positioning error. Alternatively, the annular beam may be arranged such that it evenly illuminates a small even rim around the ball when positioned correctly. Any misalignment will then show as an unevenness of this illuminated rim.

Aspects of the invention can also be achieved without the use of a heat mark on the ball and several examples are given below.

A first example uses an apparatus similar to that already described, but with the following differences. Balls are used which are coated in a photo-luminescent material which strongly emits light, or other readily detectable radiation, following exposure to radiation of a particular type, such as UV radiation. The required marking is made on the ball just before it is impacted by the club and is detected shortly afterwards by a detection means suited to the detection of the emitted radiation. Although this requires the use of a specially prepared ball, it retains the advantage of the ball being positioned randomly prior to being struck. A second example uses a ball with permanent marking which is oriented with its marks in the correct position prior to being struck by the club. The marks and the background of the ball are arranged with different reflection or colour properties. A detection means is used in conjunction with an appropriate source of light or other radiation, and is operable to interpret the reflected pattern resulting from the positions of the marks on the ball. One example of a material with a different reflective property to the normal ball material is a reflective material containing numerous small glass spheres. Another example is the use of different colours on the mark and the surrounding background and the use of a light source or filter on the light detector which preferentially detects one colour and not the other. A third example uses a small flat reflecting surface on one side surface of the ball, centred on the initial Y-Y axis position, as depicted in FIGS. 1 and 2. A light detector measures the angle of reflection of a light source at the detector as the ball passes. A ball without sidespin will maintain the reflecting surface along the pole position and the reflected beam will be directly returned as the centre of the ball passes the detector. The direction and magnitude of any deviations from this situation can be used to indicate the sidespin characteristics. A fourth example uses a ball which has different reflection or colour properties on that half of the ball which is not visible in side view at the initial position. If sidespin is not present, the initially unseen half will remain out of view to any detector monitoring a side view of the ball as it passes. If sidespin is present, the initially unseen half will be detected near the leading edge or trailing edge of the ball, depending on the direction of side spin. The magnitude of the detected part will also relate to the magnitude of sidespin. A full or partial band of different reflection or colour properties about the unseen equator may also be used. A fifth example is very similar to the previous example, except that the unseen portion is at one or both poles of the ball, i.e. the region adjacent the initial intersection of the Y-Y axis with the surface of the ball. In this instance, the detector is positioned in or adjacent the X-Z plane, for example at a position which is below and to the front of the initial ball position. A sixth example relates to the use of a permanent magnet means within the ball, with the poles of the magnet means aligned to the initial Y-Y axis of the ball. When the ball is in flight, appropriate electronic detectors are used to determine if the magnetic pole remains parallel to the Y-Y axis.

It is to be understood that the invention is not limited to the specific details described herein which are given by way of example only and that various modifications and alterations are possible without departing from the scope of the invention as defined in the appended method and apparatus claims.

1-227. (canceled)

228. A method of measuring spin characteristics, such as side spin or back spin or forward spin, of a moving ball which is hit from a stationary position; wherein the ball includes detectable object features and marking comprising one or more detectable marks, the method characterized by
(1) detecting, determining or recording event characteristics including one of a time occurrence, a time duration and a detection intensity, associated with an entry, passage or exit of the marks or object features at a reference or boundary;
characterized in that
(2) the reference or boundary is a plane or two dimensional region through which the ball passes;
(3) the reference or boundary is substantially orthogonal or close to orthogonal to the actual or intended plane in which the ball moves or to the intended or actual direction of motion of the ball;
(4) detected, determined or recorded event characteristics must include time occurrence or time duration;
(5) detection, determination or recording of spin characteristics is effected in a substantially one dimensional manner;
(6) measured spin characteristics include side spin; and
(7) measurement of side spin is associated with detecting, determining or recording marks, and object features which are leading and/or trailing edges, or object features which are upper and/or lower edges,
so as to measure or determine the spin characteristics of the moving ball.

229. A method according to claim 228, wherein event characteristics are detected or measured in side view to provide unique values for each combination of back spin and side spin.

230. A method according to claim 228, wherein marks or object features, or projected marks or projected object features, are detected or measured in a side-view and has features selected from a group comprising:
the side-view is substantially orthogonal to an axis of back spin or forward spin;
measurement of spin characteristics is associated with changes in distance or projected distance, between marks or object features, or projected marks or projected object features, between two such side-views;
measurement of back spin or forward spin characteristics is associated with changes in distance or projected distance between marks or projected marks, or changes in distance or projected distance between object features or projected object features, between two such side-views;
measurement of side spin characteristics is associated with changes in the distance or projected distance between marks or projected marks and object features or projected object features, between two such side-views;
one side view is a position, or known position, where the marks or object features, or projected marks or object features, are known prior to measurement;
one side view is a position, or known position, where the marks or object features, or projected marks or object features, are known prior to measurement and the known position is a starting position where the ball is at rest; and
one side view is a position, or known position, where the marks or object features, or projected marks or object features, are known prior to measurement; and the known position is a starting position where the ball is at rest and measurement of spin characteristics includes appropriate allowance for the ball being accelerated from rest.

231. A method according to claim 228, wherein event characteristics are associated with radiation intensity.

232. A method according to claim 228, which has one or more features selected from a group comprising:
the plane or two dimensional region contains two mutually orthogonal axes and one axis is orthogonal to the actual direction or intended direction of movement of the ball;
one axis is orthogonal to the actual direction or intended direction of movement of the ball and the other axis is orthogonal or at an acute angle to the actual direction or intended direction of movement of the ball;
the ball moves substantially in a plane which is vertical with one axis is orthogonal to the actual direction or intended direction of movement of the ball and the other axis is vertical;
the ball is a golf ball;
the spin characteristics are side spin, back spin and forward spin;
the spin characteristics are side spin and back spin;
marks or object features, or projected marks or projected object features, are detected or measured by anamorphic detection or measurement where detection or measurement is associated with different magnification on two axis which are disposed at angles to each other, including angles which are mutually orthogonal, one axis being a magnification axis and the other a compression axis, the magnification axis has relative positive magnification and the compression axis has relative negative magnification;
marks or object features are detected or measured as projected marks or projected object features;
marks or object features are detected or measured as projected marks or projected object features, where projection is in a single dimension;
measurement is taken across more than one quarter turn of back spin or forward spin; and marking comprises three or more marks or projected marks; and
measurement is made using artificial neural-type intelligence.

233. A method according to claim 228, wherein one side view is a position, or known position, where the marks or object features, or projected marks or object features, are known prior to measurement and which has one or more features selected from a group comprising:
marking comprises two marks which in the known position are disposed symmetrically about the centre of the side-view;
marks or object features, or projected marks or projected object features, are detected or measured by anamorphic detection or measurement and two marks are disposed in the known location on an axis which is parallel to the magnification axis;
marks or object features, or projected marks or projected object features, are detected or measured by anamorphic detection or measurement and two marks are disposed in the known location on an axis which is orthogonal to the magnification axis;
measurement is taken within the first quarter turn of back spin or forward spin; progressively increased side spin is associated with increased difference between the projected distance between leading edge and first mark and the projected distance between the trailing edge and the second mark; absence of difference between these projected distances is associated with absence of side spin; slicing side spin is associated with the projected distance between the leading edge and the first mark being greater than the projected distance between the trailing edge and the second mark; hooking side spin is associated with the projected distance between the leading edge and the first mark being greater than the projected distance between the trailing edge and the second mark; and
measurement is taken within the first quarter turn of back spin or forward spin and progressively increased back spin or forward spin is associated with increased change in the projected distance between marks, increasing where the two marks are disposed in the known location on an axis which is parallel to the magnification axis and decreasing where the axis is orthogonal to the magnification axis and absence of back spin or forward spin is associated with the projected distance between marks remaining substantially unchanged.

234. A method according to claim 228, which has one or more features selected from a group comprising:
marks are of substantially circular shape and are small relative to the size of the ball;
measurement is associated with an identification of the position or centre of the mark by detection of its edges;
the area of a mark is less than about 3% of the area of the side-view of the ball;
the detection of marks or object features includes screening of emission signals from the marks or object features such that signals, other than those generated at or close to the reference or boundary region, are excluded from detection;
marks or object features are detected at a plurality of locations;
marks or object features are detected at a plurality of locations and detection is anamorphic detection where the plurality of locations lie on an axis which is substantially parallel to the magnification axis;
marks or object features are detected at a plurality of locations and the measurement of the location of marks in a direction parallel to the magnification axis is associated with differences in radiation intensity associated with detection of marks or object features at the plurality of locations;
the ball comprises permanent marking which is detectable by a detection means; and
the ball comprises reflective or magnetic marking which is detectable by a detection means.

235. A method according to claim 228, wherein the surface of the ball comprises a material which emits radiation following exposure to radiation; and temporary marking, produced on the ball by the impingement of radiation on the material, is detectable by a detection means, which has one or more features selected from a group comprising:
marking comprises a region on the surface of the ball which is at a detectably different temperature to an adjacent region of the surface;
marks are produced on the surface of the ball by radiating it with electromagnetic radiation at wavelengths at which the ball has relatively high radiation absorptivity;
marks are produced on the surface of the ball by radiating it with electromagnetic radiation at wavelengths at which the ball has an absorptivity greater than 0.85;
the method of detection relates to the rate of change of temperature;
the ball is subjected to a beam of radiation and object features are detected by reflection of radiation from the ball;
the ball is subjected to a beam of radiation and object features are detected by reflection of radiation from the ball and the same measurement means, or detection means, measures or detects marks and reflected radiation from the ball;
the ball is subjected to a beam of radiation and object features are detected by reflection of radiation from the ball and the beam of radiation is pulsed and selectively detected;
object features are detected by emission of radiation at a wavelength or temperature different to the wavelengths or temperatures of the marks; and
the surface of the ball comprises a photo-luminescent material.

236. A method of measuring or determining spin characteristics, such as side spin or back spin or forward spin, of a moving ball which is hit from a stationary position by detecting marking on the ball; characterized by
(1) providing marking on a region on a surface of the ball which is at a detectably different temperature to an adjacent region of the surface; and
(2) measuring spin characteristics including side spin;
so as to measure or determine the spin characteristics of the moving ball.

237. A method of measuring or determining spin characteristics of a moving ball, as claimed claim 236 including the step of detecting or recording event characteristics associated with the entry, passage or exit of the marking at a reference or boundary so as to measure the spin characteristics of the moving ball, which has one or more features selected from a group comprising:
event characteristics are associated with time or time duration;
event characteristics are associated with radiation intensity;
the reference or boundary comprises a plane or two dimensional region across which the ball moves;
the plane or two dimensional region contains two mutually orthogonal axes; and one axis is orthogonal to the actual direction or intended direction of movement of the ball;
one axis is orthogonal to the actual direction or intended direction of movement of the ball; and the other axis is orthogonal or at an acute angle to the actual direction or intended direction of movement of the ball;
the ball moves substantially in a plane which is vertical, one axis is orthogonal to the actual direction or intended direction of movement of the ball and the other axis is vertical;
object features include a leading edge, a trailing edge or one or both side edges, such as an upper or lower edge, of the ball;
detecting, determining or recording event features is effected in a one dimensional manner;
the ball is a golf ball;
the spin characteristics are side spin, back spin and forward spin;
the spin characteristics are side spin and back spin;
marks or object features, or projected marks or projected object features, are detected or measured by anamorphic detection or measurement; where detection or measurement is associated with different magnification on two axis which are disposed at angles to each other, including angles which are mutually orthogonal, one axis being a magnification axis and the other a compression axis, the magnification axis has relative positive magnification and the compression axis has relative negative magnification;
marks or object features are detected or measured as projected marks or projected object features;
marks or object features are detected or measured as projected marks or projected object features, where projection is in a single dimension;
marks or object features, or projected marks or projected object features, are detected or measured in a side-view which is substantially orthogonal to the axis of back spin or forward spin;
measurement of spin characteristics is associated with changes in distance or projected distance, between marks or object features, or projected marks or projected object features, between two such side-views;
measurement of back spin or forward spin characteristics is associated with changes in distance or projected distance between marks or projected marks, or changes in distance or projected distance between object features or projected object features, between two such side-views;
measurement of spin characteristics is associated with changes in distance or projected distance, between marks or object features, or projected marks or projected object features, between two such side-views and measurement of side spin characteristics is associated with changes in the distance or projected distance between marks or projected marks and object features or projected object features, between two such side-views;
measurement of spin characteristics is associated with changes in distance or projected distance, between marks or object features, or projected marks or projected object features, between two such side-views; and one side view is a position, or known position, where the marks or object features, or projected marks or object features, are known prior to measurement;
measurement is taken across more than one quarter turn of back spin or forward spin; and marking comprises three or more marks or projected marks; and
a surface of the ball comprises a material which emits radiation following exposure to radiation and temporary marking, produced on the ball by the impingement of radiation on the material, is detectable by a detection means.

238. An apparatus for measuring spin characteristics, such as side spin or back spin or forward spin, of a moving ball which is hit from a stationary position; wherein the ball includes detectable object features and marking comprising one or more detectable marks, the apparatus comprising a measurement means which includes a detection means, characterized by
(1) the measurement means being operable to detect, determine or record event characteristics, such as time occurrence or time duration or detection intensity, associated with the entry, passage or exit of marks or object features at a reference or boundary;
characterized in that
(2) the reference or boundary is a plane or two dimensional region through which the ball passes;
(3) the reference or boundary is substantially orthogonal or close to orthogonal to the actual or intended plane in which the ball moves or to the intended or actual direction of motion of the ball;
(4) the measurement means is operable to at least detect, determine or record event characteristics which include time occurrence or time duration;
(5) the measurement means is operable to effect the detection, determination or recording of spin characteristics in a substantially one dimensional manner;
(6) the measurement means is operable to at least measure side spin; and
(7) the measurement means is operable to measure spin, including side spin, by detecting, determining or recording marks and object features which are leading and/or trailing edges, or object features which are upper and/or lower edges;
so as to measure or determine the spin characteristics of the moving ball.

239. An apparatus according to claim 238, wherein the apparatus is operable to detect or measure event characteristics in side view to provide separate values for each combination of back spin and side spin.

240. An apparatus according to claim 238, wherein the measurement means is operable to detect or measure marks or object features, or projected marks or projected object features, in a side-view; and which has one or more features selected from a group comprising:
the side-view is substantially orthogonal to the axis of back spin or forward spin;
the measurement means is operable to detect or measure spin characteristics by association with changes in the distance, or projected distance, between marks or object features, or projected marks or projected object features, between two such side-views;
the measurement means is operable to detect or measure back spin or forward spin characteristics by association with changes in the distance or projected distance between marks or changes in the distance or projected distance between object features, between two such side-views;
the measurement means is operable to detect or measure side spin characteristics determining changes in the projected distance between marks and object features, between two such side-views;
the measurement means is operable to know the location of marks or object features, or projected marks or object features, in a known position prior to measurement;
the known position is a starting position where the ball is at rest; and
the measurement means is operable to make appropriate allowance for the ball being accelerated from rest when measuring the spin characteristics.

241. An apparatus according to claim 238, wherein event characteristics are associated with radiation intensity.

242. An apparatus according to claim 238, which has one or more features selected from a group comprising:
the plane or two dimensional region contains two mutually orthogonal axes and one axis is orthogonal to the actual direction or intended direction of movement of the ball;
the plane or two dimensional region contains two mutually orthogonal axes, one axis is orthogonal to the actual direction or intended direction of movement of the ball and the other axis is orthogonal or at an acute angle to the actual direction or intended direction of movement of the ball;
the plane or two dimensional region contains two mutually orthogonal axes, and one axis is orthogonal to the actual direction or intended direction of movement of the ball and the other axis is vertical;
the ball is a golf ball;
the spin characteristics are side spin, back spin and forward spin;
the spin characteristics are side spin and back spin;
the apparatus includes an anamorphic detection means or anamorphic measurement means, the anamorphic detection means or anamorphic measurement means are operable to detect or measure marks or object features, or projected marks or projected object features, the anamorphic detection means or anamorphic measurement means are operable to detect or measure with different magnification on two axis which are disposed at angles to each other, including angles which are mutually orthogonal, one axis being a magnification axis and the other a compression axis, the magnification axis has relative positive magnification and the compression axis has relative negative magnification;
the measurement means is operable to detect or measure marks or object features as projected marks or projected object features;
the measurement means is operable to detect or measure marks or object features as projected marks or projected object features, where projection is a single dimension; and
the measurement means measures spin characteristics across more than one quarter turn of back spin or forward spin; and marking comprises three or more marks or projected marks.

243. An apparatus according to claim 238, wherein the measurement means is operable to detect or measure marks or object features, or projected marks or projected object features, in a side-view, the measurement means is operable to know the location of marks or object features, or projected marks or object features, in a known position prior to measurement;
and which has one or more features selected from a group comprising:
marking comprises two marks which in the known location are disposed symmetrically about the centre of the side-view;
marking comprises two marks which in the known location are disposed symmetrically about the centre of the side-view, the detection or measurement means is operable to anamorphically detect or measure marks or object features, or projected marks or projected object features and the two marks are disposed in the known location on an axis which is parallel to the magnification axis;
marking comprises two marks which in the known location are disposed symmetrically about the centre of the side-view, the detection or measurement means is operable to anamorphically detect or measure marks or object features, or projected marks or projected object features and two marks are disposed in the known location on an axis which is orthogonal to the magnification axis;
marking comprises two marks which in the known location are disposed symmetrically about the centre of the side-view, the measurement means is operable to measure side spin characteristics within the first quarter turn of back spin or forward spin, progressively increased side spin is associated with increased difference between the projected distance between leading edge and first mark and the projected distance between the trailing edge and the second mark, absence of difference between these projected distances is associated with absence of side spin, slicing side spin is associated with the projected distance between the leading edge and the first mark being greater than the projected distance between the trailing edge and the second mark, and hooking side spin is associated with the projected distance between the leading edge and the first mark being greater than the projected distance between the trailing edge and the second mark;
marking comprises two marks which in the known location are disposed symmetrically about the centre of the side-view, the measurement means is operable to measure back spin or forward spin characteristics within the first quarter turn of back spin or forward spin; progressively increased back spin or forward spin is associated with increased change in the projected distance between marks, increasing where the two marks are disposed in the known location on an axis which is parallel to the magnification axis and decreasing where the axis is orthogonal to the magnification axis. and absence of back spin or forward spin is associated with the projected distance between marks remaining substantially unchanged.

244. An apparatus according to claim 238, which has one or more features selected from a group comprising:
the detection means is operable to detect permanent marking on the ball;
the detection means is operable to detect reflective or magnetic marking on the ball;
the surface of the ball comprises a photo-luminescent material;
the surface of the ball comprises a photo-luminescent material; and the apparatus includes a marking means which is operable to produce three or more marks or projected marks on the ball; and
the measurement means includes an artificial neural-type intelligence means.

245. An apparatus according to claim 238, which has one or more features selected from a group comprising:
the marking means is operable to produce marks which are of substantially circular shape and are relatively small compared to the size of the ball;
the measurement means is operable to detect, measure or identify the position or centre of the mark by detection of its leading and trailing edges, and
the area of a mark is less than about 3% of the area of the side-view of the ball; and
further including a screening means to exclude from detection, emission signals from the marks or object features, other than those generated at or close to the reference or boundary region.

246. An apparatus according to claim 238, wherein the apparatus includes an anamorphic detection means or anamorphic measurement means, the anamorphic detection means or anamorphic measurement means are operable to detect or measure marks or object features, or projected marks or projected object features, the anamorphic detection means or anamorphic measurement means are operable to detect or measure with different magnification on two axis which are disposed at angles to each other, including angles which are mutually orthogonal, one axis being a magnification axis and the other a compression axis, the magnification axis has relative positive magnification and the compression axis has relative negative magnification, and which has one or more features selected from a group comprising:
the measurement means or detection means includes an anamorphic lens means, which is operable to anamorphically detect marks or object features, the anamorphic lens means comprises a combination of spherical lens characteristics and cylinder lens characteristics, or comprises toroidal lens characteristics;
the measurement means or detection means includes an anamorphic lens means which comprises a polymer Fresnel faceted lens;
the measurement means or detection means includes an anamorphic reflector means; which is operable to anamorphically detect marks or object features, which is off-axis, and comprises a combination of spherical reflector characteristics and cylinder reflector characteristics, or comprises toroidal reflector characteristics.

247. An apparatus according to claim 238, wherein the surface of the ball comprises a material which emits radiation following exposure to radiation, the detection means is operable to detect temporary marking, produced on the ball by the impingement of radiation on the material, and which has one or more features selected from a group comprising:
marking comprises a region on the surface of the ball which is at a detectably different temperature to an adjacent region of the surface, the detection means is operable to detect temporary marking which is at a detectably different temperature to an adjacent region of the surface;
the detection means includes a heat sensor;
the detection means includes a heat sensor which is operable to vary its output with variations in the detected heat radiation signal;
the detection means is operable to detect the rate of change of temperature;
the detection means is a pyroelectric sensor;
the detection means is a pyroelectric sensor which operates in current mode;
the detection means is operable to detect temperature or relative temperature;
the detection means is a photoconductive sensor;
the detection means is a sensor with very fast response;
the detection means is a dual element sensor;
the detection means is a slot sensor;
the detection means includes a filter means which is operable to preferentially transmit radiation emitted by marks or object features and exclude unwanted wavelengths;
the marking means is operable to produce temporary heat marking on the surface of the ball;
the marking means is operable to produce temporary heat marking on the surface of the ball and the marking means is operable to produce marking on the surface of the ball by radiating it with electromagnetic radiation at wavelengths at which the ball has relatively high radiation absorptivity;
the marking means is operable to produce temporary heat marking on the surface of the ball and the marking means is operable to produce marking on the surface of the ball by radiating it with electromagnetic radiation at wavelengths at which the ball has an absorptivity which is greater than 0.85;
the marking means is operable to produce temporary heat marking on the surface of the ball and includes a checking means, the checking means comprising an annular beam of visible light which is physically locked in alignment with the beam from the radiation emitting means and where the annular beam falls just outside the perimeter of the ball when heat marking is correctly positioned;
the marking means is operable to produce temporary heat marking on the surface of the ball; and the marking means is operable to produce temporary heat marking by thermal conductive contact;
the measurement means is operable to detect or measure object features by detection of reflected radiation from the ball;
the measurement means is operable to detect or measure object features by detection of reflected radiation from the ball and the apparatus includes a radiation emitting means which is operable to subject the ball to a beam of radiation;
the measurement means is operable to detect or measure object features by detection of reflected radiation from the ball and the same measurement means, or the same detection means, is operable to measure or detect marks in reflected radiation from the ball;
the measurement means is operable to detect or measure object features by detection of reflected radiation from the ball and the apparatus includes a radiation emitting means which is operable to subject the ball to a beam of radiation; and the radiation emitting means is operable to emit a beam of pulsed radiation and the measurement means is operable to selectively detect or measure the pulsed radiation; and
the measurement means is operable to detect or measure emission from object features at a wavelength or temperature different to the wavelengths or temperatures of the marks.

248. Apparatus for measuring or determining spin characteristics, such as side spin or back spin or forward spin, of a moving ball which is hit from a stationary position, and which includes marking of one or more detectable marks, the apparatus comprising a measurement means which includes a detection means; characterized in that, marks are at a detectably different temperature to an adjacent region of the surface; and the detection means is operable to detect marks which are at a detectably different temperature to an adjacent region of the surface so as to measure or determine the spin characteristics of the moving ball, including at least the side spin characteristics.

249. An apparatus according to claim 248, wherein the detection means includes a heat sensor and which has one or more features selected from a group comprising:
the heat sensor is operable to vary its output with variations in the detected heat radiation signal;
the detection means is operable to detect the rate of change of temperature;
the detection means is a pyroelectric sensor;
the detection means is operable to detect temperature or relative temperature;
the detection means is a lead selenide sensor;
the detection means is a sensor with a fast response;
the detection means is a dual element sensor;
the detection means includes a filter means which is operable to preferentially transmit radiation emitted by marks or object features and exclude unwanted wavelengths;
the marking means is operable to produce temporary heat marking on the surface of the ball;
the marking means is operable to produce marks which are of substantially circular shape and are relatively small compared to the size of the ball;
the measurement means is operable to detect, measure or identify the position or centre of the mark by detection of its leading and trailing edges;
the area of a mark is less than about 3% of the area of the side-view of the ball;
the screening means is operable to exclude from detection emission signals from the marks or object features, other than those generated at or close to the reference or boundary region;
the measurement means or detection means includes an anamorphic lens means, which is operable to anamorphically detect marks or object features, the anamorphic lens means comprises a combination of spherical lens characteristics and cylinder lens characteristics, or comprises toroidal lens characteristics;
the measurement means is operable to detect or measure emission from object features at a wavelength or temperature different to the wavelengths or temperatures of the marks;
the measurement means includes an artificial neural-type intelligence means; and
a surface of the ball comprises a photo-luminescent material.

250. An apparatus according to claim 248, in which the detection means is operable to detect or record event characteristics associated with the entry, passage or exit of marks or regions at a reference or boundary so as to measure or determine the spin characteristics of the moving ball, and which has one or more features selected from a group comprising:
event characteristics are associated with time or time duration;
event characteristics are associated with radiation intensity;
the reference or boundary comprises a plane or two dimensional region across which the ball moves;
the reference or boundary comprises a plane or two dimensional region across which the ball moves and wherein the plane or two dimensional region contains two mutually orthogonal axes and one axis is orthogonal to the actual direction or intended direction of movement of the ball;
the reference or boundary comprises a plane or two dimensional region across which the ball moves and one axis is orthogonal to the actual direction or intended direction of movement of the ball and the other axis is orthogonal or at an acute angle to the actual direction or intended direction of movement of the ball;
the reference or boundary comprises a plane or two dimensional region across which the ball moves and one axis is orthogonal to the actual direction or intended direction of movement of the ball and the other axis is vertical;
object features include a leading edge, a trailing edge or one or both side edges of the ball.
the ball is a golf ball;
the spin characteristics are side spin, back spin and forward spin;
the spin characteristics are side spin and back spin;
the apparatus includes an anamorphic detection means or anamorphic measurement means, the anamorphic detection means or anamorphic measurement means are operable to detect or measure marks or object features, or projected marks or projected object features, the anamorphic detection means or anamorphic measurement means are operable to detect or measure with different magnification on two axis which are disposed at angles to each other, including angles which are mutually orthogonal, one axis being a magnification axis and the other a compression axis, the magnification axis has relative positive magnification and the compression axis has relative negative magnification;
the measurement means is operable to detect or measure marks or object features as projected marks or projected object features;
the measurement means is operable to detect or measure marks or object features as projected marks or projected object features, where projection is a single dimension;
the measurement means is operable measure marks or object features, or projected marks or projected object features, in a side-view which is substantially orthogonal to the axis of back spin or forward spin;
the measurement means is operable to measure marks or object features, or projected marks or projected object features, in a side-view which is substantially orthogonal to the axis of back spin or forward spin and the measurement means is operable to measure spin characteristics by association with changes in the distance, or projected distance, between marks or object features, or projected marks or projected object features, between two such side-views;
the measurement means is operable to measure marks or object features, or projected marks or projected object features, in a side-view which is substantially orthogonal to the axis of back spin or forward spin, and the measurement means is operable to measure back spin or forward spin characteristics by association with changes in the distance or projected distance between marks or changes in the distance or projected distance between object features, between two such side-views;
the measurement means is operable to measure marks or object features, or projected marks or projected object features, in a side-view which is substantially orthogonal to the axis of back spin or forward spin, and the measurement means is operable to measure side spin characteristics by association with changes in the projected distance between marks and object features, between two such side-views;
the measurement means is operable to measure marks or object features, or projected marks or projected object features, in a side-view which is substantially orthogonal to the axis of back spin or forward spin, and the measurement means is operable to know the location of marks or object features, or projected marks or object features, in a known position prior to measurement;
the measurement means detects or measures spin characteristics across more than one quarter turn of back spin or forward spin and the marking comprises three or more marks or projected marks; and
the surface of the ball comprises a material which emits radiation following exposure to radiation; the detection means is operable to detect temporary marking, produced on the ball by the impingement of radiation on the material.
